(19) United States
(12) Patent Application Publication
(10) Pub. No.: US 2012/0151873 A1
(43) Pub. Date: Jun. 21, 2012

(54) SYSTEM FOR THE STERILE FILLING OF PRODUCTS, ESPECIALLY BEVERAGES INTO BOTTLES OR SIMILAR RECEPTACLES

(75) Inventor: Thomas Niehr, Erkelenz (DE)

(73) Assignee: KHS GmbH, Dortmund (DE)

(21) Appl. No.: 13/393,289

(22) PCT Filed: Sep. 10, 2010
(86) PCT No.: PCT/EP2010/005564

§ 371 Date: Feb. 29, 2012

(30) Foreign Application Priority Data
Sep. 11, 2009 (DE) 10 2009 040 924.6

(51) Int. Cl. B65B 55/18; B67C 3/22

(52) U.S. Cl. 53/167; 53/281

(57) ABSTRACT

A system for filling bottles or similar receptacles in a sterile or aseptic manner comprises a receptacle supplying mechanism, by means of which the receptacles that are to be filled are supplied to the system, a receptacle discharge mechanism, by means of which the full, closed receptacles are removed from the system, at least one unit designed as a filler for filling the receptacles, a unit designed as a closing device for closing the full receptacles, and a housing forming at least one sterile space, inside which at least an area of the receptacles that includes a receptacle opening is accommodated during the filling and closing process and to which a sterile gaseous and/or vaporous medium can be fed.

The invention relates to a system according to patent claim 1 or 3.

Systems are known for the sterile filling of products, especially beverages, into bottles or similar receptacles, whereby the receptacles are received into these systems in a sterile space, at least during the filling and the subsequent closing but also on transport routes in between, at least with their area which has the respective receptacle opening, with the sterile space, during the operation of the system, being fed with a sterile vaporous and/or gaseous medium, for example with sterile air.

The task of the invention is to show a system with which improved quality and operational safety during sterile filling and closing of receptacles is ensured. To solve this task, a system is designed according to patent claim 1 or 3.

In the system according to the invention, the housing forming the actual sterile space is enclosed, at least in a partial area, by a further housing which forms the receptacle supplying mechanism and the receptacle discharge mechanism of the system and into which flows the sterile space with a receptacle inlet and a receptacle outlet. If the sterile space is limited by wall elements between which, during system operation, there is a relative movement, the transitions between such wall elements or locally provided seals are preferably received in the internal space of the further housing.

Further developments, advantages and potential applications of the invention also come from the following description of execution examples and from the figures. In principle, all features described and/or depicted, for themselves or any combination, are the subject of the invention, irrespective of their summary in the claims or their retrospectivity. The content of the claims is also made a component part of the description.

Hereinafter, the invention is clarified using the figures by means of execution examples:

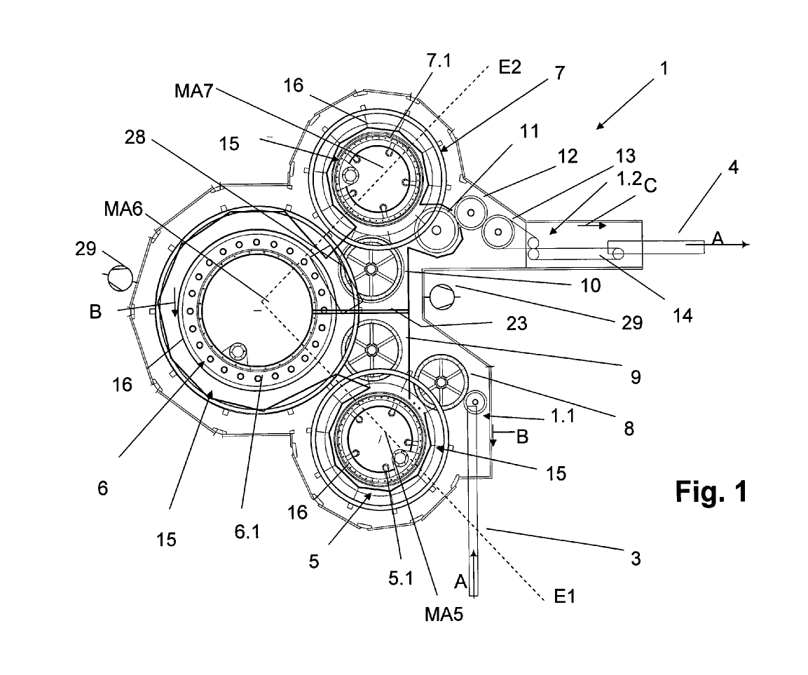

FIG. 1 shows, in a simplified representation and in plan view, a system for the sterile filling of receptacles in the form of bottles with a liquid charge as well as for subsequent closing of the receptacles;

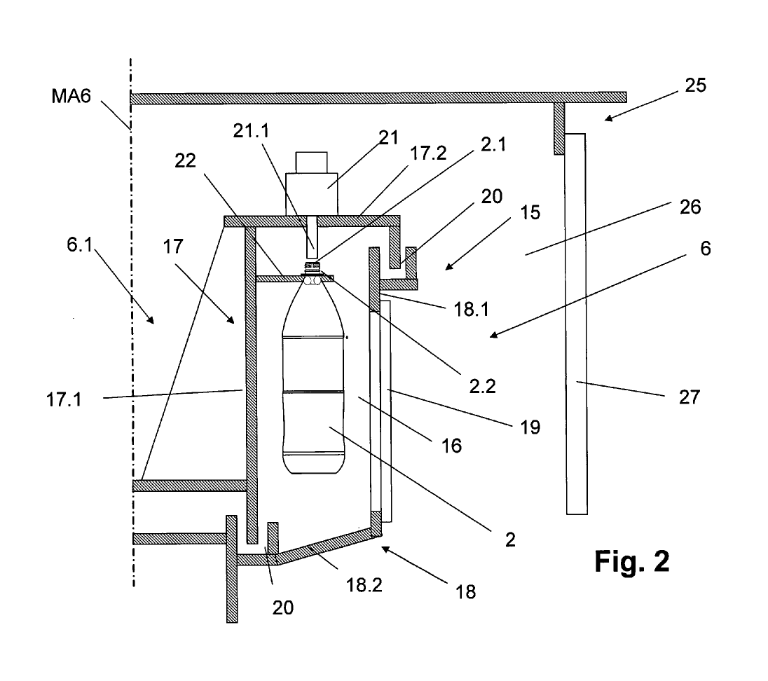

FIG. 2 shows, in a simplified schematic partial representation, a vertical section through the part of the system of FIG. 1 having the filling machine and the filling unit, respectively;

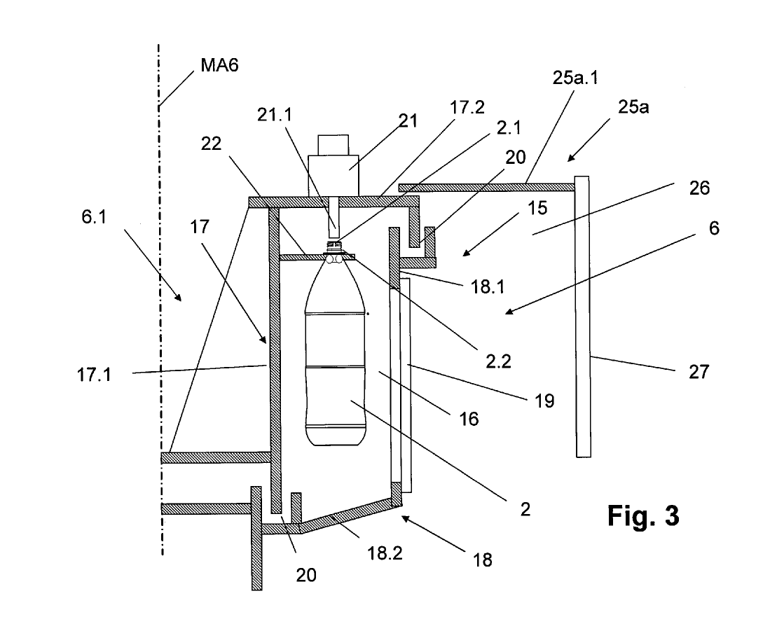

FIG. 3 a shows a representation similar to FIG. 2, for a further embodiment of the invention.

The system generally referred to as 1 in the figures serves to fill receptacles in the form of bottles 2 with a liquid charge as well as to close the filled bottles 2, always under sterile conditions. The bottles 2 to be filled are delivered, via an outer transporter 3, to the system 1 or a receptacle supplying mechanism 1.1 of the system. The filled and closed bottles 2 are delivered, at a receptacle discharge mechanism 1.2 of the system 1, via an outer transporter 4, to a further application, for example a labelling machine following system 1. The bottles 2, for the embodiment shown, are those made of plastic, for example PET, which, as known in the art, are for instance designed, at their bottlenecks below the respective bottle mouth 2.1, with a protruding mouth flange 2.2.

For the sterile filling as well as for the closing of these bottles under sterile conditions, the system 1 for instance comprises of three units in the form of a steriliser 5, of an activator 6 and of a filler 7 which, in this order, are provided successively in a receptacle transport direction A through the system 1. Furthermore, the system comprises of several of the system's internal receptacle transport elements, such as a transport star 8 forming the bottle or receptacle feed inlet of the steriliser 5, a transport star 8 forming the bottle or receptacle handover between the steriliser 5 and the filler 6, a transport star 10 forming the bottle or receptacle handover between the filler 6 and the filler closing device 7 as well as several transport stars 11, 12 and 13 forming the receptacle discharge of the closing device with subsequent transporter 14.

The steriliser 5, the filler 6 and the filler 7, for the embodiment represented, are always machines or units of rotary design. Accordingly, the steriliser 5 includes a rotor 5.1 rotatably drivable around a vertical machine axis MA5, at whose periphery a plurality of treatment stations is formed on which the bottles 2, which are delivered via the receptacle supplying mechanism 1.1 to the transport star 8 and with their bottle axes oriented in a vertical direction, are sterilised.

The filler 6 includes a rotor 6.1 rotatably drivable around a vertical machine axis MA6, at whose periphery a plurality of filling positions is formed at which, for example controlled by volume or quantity, the bottles 2 are filled with the liquid charge and to which the bottles 2 are delivered individually and still with their bottle axes oriented in a vertical direction via the transport star 9.

The filler 7 includes a rotor 7.1 rotatably drivable around a vertical machine axis MA7, at whose periphery a plurality of closing positions is formed to which the filled bottles 2 are delivered individually and also with their bottle axes oriented in a vertical direction via the transport star 10 for the closing and from which the closed bottles 2 are removed successively with the transport star 11.

In the embodiment represented, the rotors 5.1, 6.1 and 7.1 essentially are of a circular design so that, for the steriliser 5, filler 6 and filler 7, there results a centreless design which enables, within the space enclosed by the particular rotor 5.1, 6.1 or 7.1, the provision of further functional elements not rotating with the rotor.

The transport stars 8-13 are also drivable around vertical axes. It is understood that the rotors 5.1, 6.1 and 7.1 as well as all transport stars 8-13 are synchronous during operation of the system 1 and driven such that the bottles 2 delivered via the outer transporter 3 are sterilised following handover to the steriliser 5 on the angular range of the rotary motion of the rotor 5.1 between the transport star 8 and the transport star 9, then filled following handover to the rotor 6.1 on the angular range of the rotary motion of this rotor between the transport star 9 and the transport star 10, then closed following handover to the rotor 7.1 on the angular range of the rotary motion of this rotor between the transport star 10 and the transport star 11 and subsequently reach, via the transport stars 11-13 and the following system-internal transporter 14, the receptacle discharge mechanism 1.2 or the outer transporter 4.

As can be seen from FIG. 1, the steriliser 5, activator 6 and filler 7 are arranged such that the machine axes MA5, MA6 and MA7 in plan view of the system 1, define the corner points of a triangle (triangular configuration). Following this, the closing device 11 is shown. In variants not shown, for more than three treatment machines, a partial circle or partial polygon configuration shall be selected. Within this triangle, but at least within an angular range of two vertical planes E1 and E2, all transport stars 8-13 are arranged. For this, the plane E1 is defined by the two machine axes MA5 and MA6 and the plane E2 by the two machine axes M6 and MA7. The planes E1 and E2 enclose an angle of clearly smaller than 180°, preferably smaller than 120°. Through this arrangement of the transport stars 8-10 in respect of the steriliser 5, activator 6 and filler 7 there is, for instance, an optimum clarity and also accessibility of the system 1 and, in doing so, especially of the steriliser 5, activator 6 and filler 7, to include optical monitoring of the functionality of the system 1 as well as for maintenance and repair purposes.

For the sterilisation of the bottles 2 as well as for the filling and closing of these bottles under sterile conditions, the system 1 is designed with an inner housing 15 which forms an internal space or a sterile space 16 closed towards the outside. Housed in this sterile space 16 are, for instance, the steriliser 5, activator 6 and filler 7, but at least these units' functional elements directly interacting with the bottles 2 as well as all bottle transport elements and guiding elements which are provided in the receptacle transport direction A between the receptacle feed inlet of the steriliser 5 formed by the transport star 8 and the receptacle discharge of the filler 7 or closing device 11 formed by the transport star 12, i.e. in the sterile space 16, the transport stars 9-10 are also specially arranged, but at least the functional elements of these transport stars directly interacting with the bottles 2.

FIG. 2 shows the design of the housing 15 in the area of the activator 6 or in the area of the local filling positions. There, the housing 15 comprises a wall element 17 formed by the rotor 6.1 which finishes, with a circular-cylindrical wall section 17.1 concentrically enclosing the machine axis MA6, the sterile space 16 relating to this machine axis radially on the inside and, with an upper annular wall section 17.2 concentrically enclosing the machine axis, finishes the sterile space 16 at its top, as well as a wall element 18 not rotating with the rotor 6.1 which finishes, with a wall section 18.1 enclosing the machine axis MA6, the sterile space 16 relating to this machine axis radially on the outside and finishes, with a wall section 18.2, the sterile space 16 at the bottom. The wall section 18.1 is, at least in partial areas, designed transparently, i.e. it consists of panes or windows 19 made of glass or of a crystal clear plastic. Through the windows 19, the mode of operation of the activator 6 can be visually monitored. One labyrinth seal 20 each is provided at the transitions between the wall elements 17 and 18.

As FIG. 2 also shows, the particular filling position of the activator 6 for example is formed by a filling element 21 and a receptacle carrier 22 on which the particular bottle 2 is held suspended by its mouth flange 2.2, that is below a filling or discharge tube 21.1 of the filling element 21 reaching into the sterile space 16, which, with the exception of this filling or discharge tube, is located above the wall section 17.2 and thus outside the sterile space 16. Accordingly, the inner housing 15 is also in the area of the steriliser 5, filler 7 and closing device 11, i.e. the sterile space 16 is also limited there by the particular wall element corresponding with the wall element 17 formed by the rotor 5.1 or 7.1 and by the wall element corresponding with the wall element 18 not rotating with the rotor 5.1 or 7.1. Instead of the filling element 21, the treatment positions of the steriliser 5 or activator 6 for example feature a treatment head via which the media used for sterilising are also introduced into the bottles 2 also held there suspended by their mouth flange 2.2. Instead of the filling element 21, the closing positions of the closing device 11 have corresponding closing elements for closing the bottles 2. Just as in the area of the activator 6, in the area of the steriliser 5 and of the filler 7, too, the local outer wall elements not rotating with the rotor 5.1 or 7.1 are, at least in partial areas, designed as see-through panes 19. The system's internal transport elements (especially transport stars 8-13) are at least, for the most part, also designed for suspended reception of the bottles 2.

In the area of the activator 6, the sterile space 16 is designed with an inner vertical partition wall 23 which, for the embodiment represented, starting from wall element 17 radially to the machine axis MA6, reaches to an outer wall section 24 of the housing 15. The partition wall 23 which, of course, is not linked with the wall element 17 but only reaches close to this wall element, thus extends through the space between the two transport stars 9 and 10.

In addition to the inner housing 15, the system 1 has an outer housing 25 which encloses the inner housing 15 at a distance (space-within-space concept) and forms an internal space 26 into which the inner housing 15, the functional elements arranged at the top of the housing 15 (e.g. filling elements 21), the transport stars 8, 12 and 13 as well as the transporter 14 are received. The outer housing 25 further forms the receptacle supplying mechanism 1.1 and the receptacle discharge mechanism 1.2 and, preferably, always forms a lock-type chamber there.

Furthermore, the outer transporters 3 and 4 reach into the internal space 26, with the transporter 3 preferably designed as a receptacle guide on which the bottles 2 are held suspended with their mouth flange 2.2 and are moved on by conveyor air or blown air. This design, for instance, has the advantage that moving, mechanical transport elements with which additional germs could be transported through the receptacle feed inlet 1.1 into the internal space 26, are being avoided.

At least on the part which encloses the steriliser 5, activator 6 and filler 7 on their side facing away from the transport stars 8-10, the housing 25 or its outer wall is formed of panes or windows 27 made of glass or of a crystal clear plastic so that, through the windows 27 and 29, the mode of operation of the system 1 or its units can be visually observed or controlled. At the top of the housing 25, a unit 28 for producing sterile air is provided whose discharge in the area of the partition wall 23 flows into the sterile space 16 and with which the sterile space 16 is fed sterile air with a pressure P1 which is above the ambient pressure or normal pressure PN. Through the partition wall 23 results a sterile air flow divided into two, generated by unit 28, through the sterile space 16, this being, on the one hand, a flow from about the partition wall 23 or the transport star 10 along the part enclosing the activator 6 and the closing device 5 of the sterile space 16 (arrow B), with this airflow then exiting at least partially at the receptacle supplying mechanism 1.1. A second flow of the sterile air (arrow C) in turn runs from the partition wall 23 or the transport star 10 along the part of the sterile space 16 enclosing the closing device 11 and escapes at least partially at the receptacle discharge mechanism 1.2 into the atmosphere. As the receptacle inlet and the receptacle outlet of the inner housing 15 are located within the outer housing 25 or within the internal space 26 and, also, an absolutely tight closure of the sterile space 16, especially via the labyrinth seals 20 to the internal space 26 through the space-within-space concept, is not mandatory, the internal space 26 is thus fed with sterile air from the unit 28, with a pressure P2 which is smaller than the pressure P1 in the sterile space 16 but greater than the ambient pressure PN.

As FIG. 2 shows, the outer housing 25 covers, with an upper wall section 25.1, the system 1 on its entire top, that is especially in the area of the filler 7, but also in the area of the steriliser 5 and activator 6 and of the closing device 11, so that the filling elements 21 as well as the corresponding functional elements of the treatment positions or closing positions of the steriliser 5, activator 6 and closing device 11 are located within the internal space 26 of the housing 25.

FIG. 3 shows, in a representation similar to FIG. 2, a modified embodiment in which the outer housing 25a is designed such that, with its wall section 25a.1 limiting the internal space 26 at the top, it only reaches close to the wall element 17 formed by the rotor, with the functional elements of the filler 7 provided at the top of the inner housing 15, but also those of the steriliser 5, activator 6 and of the closing device 11, being located outside the internal space 26 of the outer housing 25a.

29 designates blowers in FIG. 1 with which excess air from the internal space 26 is released into the environment. Through the arrangement of the blowers 29 at the housing 25 or 25a between the receptacle supplying mechanism 1.1 and the receptacle discharge mechanism 1.2, i.e. in the embodiment represented in the centre or about in the centre of the housing 25 or 25a, an optimum or equal distribution of the sterile air from the sterile space 16 in the internal space 26, is achieved.

Through the space-within-space concept, the sterile space 16 through the housing 15 is also separated from the internal space 26 insofar as the sterile space 16 is only connected in the area of the transport stars 8 and 11 or in the area of local receptacle inlets or outlets as well as possibly through leakage in the area of the seals 20 with the internal space 26, and the internal space 26 essentially only connected via the openings forming the receptacle supplying mechanism 1.1 and the receptacle discharge mechanism 1.2 or receptacle inlets or outlets with the outer space 30, i.e. the environment.

Through the blower 29, it is ensured that, in the inner space 26, too, a directional gas flow is formed and thus the very high-quality seals and bearings, drives etc. remain protected from the outside atmosphere. In particular, during maintenance and cleaning work, protection remains if the sterile space 16 must be opened.

In a variant not shown, gas is aspired from the internal space 26 at the height of the transport stars (analogous to version FIG. 1) and subsequently introduced into the internal space 26 on the opposite side.

Through the use of the inner housing 15 and of the outer housing 25 or 25a of the space-within-space concept implemented with these housings, there results a particularly high quality of the sterile or aseptic filling of products. The loading of seals, bearings and other functional elements of the whole part of the system 1 enclosed by the housing 25 or 25a, especially also within the sterile space 16 through dirt, temperature change and/or draught in a production hall etc., is reduced substantially. Such components are thus subjected to minor wear or can be produced with a lower quality, especially also regarding the materials used.

Especially when the space 26 is at least partly accessible, a direct influence of the outer atmosphere or of the atmosphere of a production hall on the sterile space 16 is also avoided if, with the housing 25 or 25a closed, opening of the sterile space 16 is required, for example for maintenance or repair purposes. Through the use of the windows 19 and 27 as well as through the special arrangement of the units and transport stars in the triangular formation or configuration, there further results an improved transparency and clarity.

The invention was described above using execution examples. It is understood that changes as well as modifications are possible without thus departing from the idea on which the invention is based.

Through the space-within-space concept, the sterile space 16 is thus separated by the housing 15 from the internal space 26 insofar as the sterile space 16 is only connected in the area of the transport stars 8 and 11 or in the area of local receptacle inlets or outlets as well as possibly through leakage in the area of the seals 20 with the internal space 26, and the internal space 26 essentially only connected via the openings forming the receptacle supplying mechanism 1.1 and the receptacle discharge mechanism 1.2 or receptacle inlets or outlets with the environment.

In a further arrangement of the present invention, it is intended that at the receptacle supplying mechanism 1.1 and/or at the receptacle discharge mechanism 1.2 sensors, probes or similar means for registering a fluid flow are arranged, with these means intended to register a gas flow exiting from the receptacle supplying mechanism 1.1 and/or receptacle discharge mechanism. These means generate a signal which informs of whether or not a fluid discharges from the receptacle treatment machine. Through connection with a suitable, preferably electronic or computer-based evaluation device it can thus be ensured that there is a constant fluid flow exiting from the machine whereby the ingress of outside air, germs or other negative influences or impurities into the receptacle treatment machine is safely avoided.

### REFERENCE SYMBOL LIST

1 systems
2 bottle
1.1 receptacle supplying mechanism
1.2 receptacle discharge mechanism
2.1 bottle mouth
2.2 mouth flange
3, 4 outer transporter
5 steriliser
5.1 rotor
6 activator and dryer
6.1 rotor
7 filler
7.1 rotor
8-10 transport star
11 closing device
12-13 transport star
14 transporter
15 inner housing
16 sterile space
17 wall element
17.1, 17.2 wall section
18 wall element
18.1, 18.2 wall section
19 window
20 labyrinth seal
21 filling element
21.1 filling tube
22 receptacle carrier
23 partition wall
24 wall section
25, 25a outer housing
25a. 1 wall section
26 internal space
27 window
28 unit for generating sterile air
29 blower
30 outer space
A transport direction of the bottles 2
B, C flow direction of the sterile air
E1, E2 plane
MA5, MA6, MA7 machine axis

1-19. (canceled)

20. An apparatus for aseptic filling of receptacles, said system comprising a receptacle supplying mechanism for supplying receptacles, a filler unit for filling the receptacles, a closing unit for closing the full receptacles, a receptacle discharge mechanism for removing full, closed receptacles, a first housing forming at least one sterile space for accommodating therein, during the filling and closing process, at least an area of a receptacle that includes a receptacle opening and into which a sterile gaseous and/or vaporous medium is fed, and a second housing that at least partially encloses the first housing, the second housing forming the receptacle supplying mechanism and the receptacle discharge mechanism, wherein the at least one sterile space is disposed at a receptacle inlet and at a receptacle outlet flowing into an internal space of the second housing.

21. The apparatus of claim 20, further comprising a sterilizer unit and an activator unit disposed along a receptacle transport direction before the filler unit, and first and second receptacle transport elements for connecting the filler unit, the sterilizer unit and the activator unit, wherein the sterilizer unit, the activator unit, the filler unit, and the closing unit are arranged in a formation selected from the group consisting of a triangle and a part circle, and wherein the receptacle transport elements are arranged within a common angular range of the formation.

22. The apparatus of claim 21, further comprising third and fourth receptacle transport elements, wherein the receptacle transport elements are arranged within a common angular range of the formation.

23. A system for aseptic filling of receptacles, said system comprising a receptacle supplying mechanism for delivering the receptacles to be filled, at least one activator unit for filling the receptacles, a receptacle discharge mechanism for removing filled and closed receptacles, at least one filler unit for closing the filled receptacles, a first housing that forms at least one sterile space in which the receptacles each are received with a receptacle area having one receptacle opening during the filling and closing and that can be fed with a sterile gaseous and/or vaporous medium, a sterilizer disposed along a receptacle transport direction before the at least one activator unit, and receptacle transport elements, wherein the sterilizer, the at least one activator unit, and the at least one filler unit are arranged in a triangular formation, and wherein the receptacle transport elements are arranged within a common angular range of the triangular formation.

24. The apparatus of claim 23, further comprising a second housing that encloses the first housing in at least one partial area and forms the receptacle supplying mechanism and the receptacle discharge mechanism, with the at least one sterile space being disposed at a receptacle inlet and at a receptacle outlet flowing into an internal space of the second housing.

25. The apparatus of claim 20, wherein the at least one sterile space fully accommodates the receptacles.

26. The apparatus of claim 20, wherein the second housing at least partially encloses the first housing at a distance.

27. The apparatus of claim 20, wherein the first housing is fully received into the second housing.

28. The apparatus of claim 20, wherein the second housing encloses the first housing only in a partial area such that the first housing extends outside the internal space of the second housing.

29. The apparatus of claim 20, further comprising a transport element at which treatment positions are formed for the receptacles, and wherein, in the area of the transport element, the at least one sterile space is limited at least by first and second wall elements of the housing, wherein the first wall element moves along with the transport element and the second wall element does not move with the transport element.

30. The apparatus of claim 29, further comprising a labyrinth seal between the first and second wall elements, the seal being received in the internal space of the second housing.

31. The apparatus of claim 20, further comprising a gas-feeding device for feeding the at least one sterile space with the sterile medium such that the pressure of the sterile medium in the at least one sterile space exceeds ambient pressure.

32. The apparatus of claim 31, wherein the internal space of the second housing is configured to be fed with the sterile medium.

33. The apparatus of claim 32, wherein the pressure within the internal space of the second housing is less than the pressure in the at least one sterile space but greater than ambient pressure.

34. The apparatus of claim 29, wherein the wall elements limiting the at least one sterile space and/or the internal space of the second housing comprise at least one window made of a see-through material.

35. The apparatus claim 20, wherein the at least one sterile space is configured for a flow of the sterile medium in a first flow direction from a medium inlet in the direction of the receptacle supplying mechanism and in a second flow direction from a medium inlet to the receptacle discharge mechanism.

36. The apparatus of claim 35, wherein a partial flow of the first flow direction and/or a partial flow of the second flow direction is designed in the direction of at least one central suction unit.

37. The apparatus of claim 35, further comprising at least two central suction arranged opposite one another.

38. The apparatus of claim 35, further comprising at least one central suction unit that takes gas or air from the space between the at least one sterile space and the housing and introduces the gas or air into a space between at least one sterile space and a housing of an adjoining treatment machine.

39. The apparatus of claim 20, wherein the second housing, in the area of the receptacle supplying mechanism and/or in the area of the receptacle discharge mechanism forms a pre- or lock chamber into which an outer transporter projects, for delivery or discharge of the receptacles.
